(19) United States
(12) Patent Application Publication
(10) Pub. No.: US 2026/0261060 A1
(43) Pub. Date: Sep. 3, 2026

(54) TERMINAL BLOCK AND LAMINATED BUSBAR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Atsuya SAIJO, Mie (JP); Daisuke HASHIMOTO, Mie (JP); Kentaro TACHI, Mie (JP); Tomoki ABE, Mie (JP); Yasuhiro KUDO, Mie (JP); Yoshitomo TSUJII, Mie (JP)

(21) Appl. No.: 18/863,644

(22) PCT Filed: Apr. 26, 2023
(86) PCT No.: PCT/JP2023/016424

§ 371 Date: Nov. 7, 2024

(30) Foreign Application Priority Data
May 16, 2022 (JP) 2022-080173
Nov. 10, 2022 (JP) 2022-180394

(51) Int. Cl. H01R 9/22; H01R 4/02; H01R 9/24; H01R 25/16

(52) U.S. Cl. CPC H01R 9/223; H01R 4/029; H01R 9/24; H01R 25/162; H01R 2201/10

(57) ABSTRACT

A terminal block to be fixed to a device includes a laminated busbar formed into an elongated shape and a block body to be fixed to the device while holding the laminated busbar. The laminated busbar includes a plurality of busbars laminated on each other. The plurality of busbars are held in a laminated state relatively immovably in a lamination holding region in one partial location in a longitudinal direction of the laminated busbar, and the plurality of busbars are laminated in a relatively shiftable state in a separation region in another location in the longitudinal direction of the laminated busbar.

### TECHNICAL FIELD

The present disclosure relates to a terminal block and a laminated busbar.

### BACKGROUND

Patent Document 1 discloses an inverter terminal block provided with an electrical conductor formed by connecting an inverter-side connection terminal and a motor-side connection terminal by a braided wire. Patent Document 1 also discloses an inverter terminal block in which an inverter-side connection terminal and a motor-side connection terminal are connected by both ends of one busbar.

### PRIOR ART DOCUMENT

### Patent Document

Patent Document 1: International Publication No. WO 2011/055806

### SUMMARY OF THE INVENTION

### Problems to be Solved

However, according to the configuration in which the inverter-side connection terminal and the motor-side connection terminal are connected by the braided wire, there is a problem of high component cost. Further, according to the configuration in which the inverter-side connection terminal and the motor-side connection terminal are connected by the both ends of the one busbar, there is a problem of difficulty in absorbing a position shift with respect to a connection destination component.

Accordingly, the present disclosure aims to provide a terminal block and a laminated busbar excellent in position shift absorption performance and capable of reducing cost.

### Means to Solve the Problem

A terminal block of the present disclosure is to be fixed to a device and provided with a laminated busbar formed into an elongated shape and a block body to be fixed to the device while holding the laminated busbar, the laminated busbar including a plurality of busbars laminated on each other, and the plurality of busbars being held in a laminated state relatively immovably in a lamination holding region in one partial location in a longitudinal direction of the laminated busbar, the plurality of busbars being laminated in a relatively shiftable state in a separation region in another location in the longitudinal direction of the laminated busbar.

Further, a laminated busbar of the present disclosure is formed into an elongated shape and provided with a plurality of busbars laminated on each other, the plurality of busbars being held in a laminated state relatively immovably in a lamination holding region in one partial location in a longitudinal direction of the laminated busbar, the plurality of busbars being laminated in a relatively shiftable state in a separation region in another location in the longitudinal direction of the laminated busbar.

### Effect of the Invention

According to the present disclosure, it is possible to provide a terminal block and a laminated busbar excellent in position shift absorption performance and capable of reducing cost.

### BRIEF DESCRIPTION OF THE DRAWINGS

FIG. 1 is a schematic diagram showing a mechatronically integrated unit according to an embodiment.

FIG. 2 is a perspective view showing a terminal block.

FIG. 3 is a section along III-III of FIG. 2.

FIG. 4 is a section along IV-IV of FIG. 3.

FIG. 5 is an enlarged view of a part A of FIG. 3.

FIG. 6 is a section showing a terminal block according to a modification.

FIG. 7 is a section showing a terminal block according to another modification.

### DETAILED DESCRIPTION TO EXECUTE THE INVENTION

### Description of Embodiments of Present Disclosure

First, embodiments of the present disclosure are listed and described below.

The terminal block of the present disclosure is as follows.

(1) The terminal block of the present disclosure is to be fixed to a device and provided with a laminated busbar formed into an elongated shape and a block body to be fixed to the device while holding the laminated busbar, the laminated busbar including a plurality of busbars laminated on each other, and the plurality of busbars being held in a laminated state relatively immovably in a lamination holding region in one partial location in a longitudinal direction of the laminated busbar, the plurality of busbars being laminated in a relatively shiftable state in a separation region in another location in the longitudinal direction of the laminated busbar.

According to this terminal block, the plurality of busbars are held in the laminated state relatively immovably in the lamination holding region in the one partial location in the longitudinal direction of the laminated busbar, and the plurality of busbars are laminated in the relatively shiftable state in the separation region in the other location in the longitudinal direction of the laminated busbar. Thus, the laminated busbar can be easily bent in a lamination direction in the region in the other location in the longitudinal direction of the laminated busbar. Thus, position shift absorption performance is better as compared to a busbar formed of one metal plate. Further, since the plurality of busbars are held in the laminated state relatively immovably in the lamination holding region in the one location, a configuration for holding the laminated busbar in the laminated state at a low cost can be realized as compared to the case where the plurality of busbars are held in the laminated state relatively immovably in a plurality of locations.

(2) In the terminal block of (1), the lamination holding region may be located in a middle in the longitudinal direction of the laminated busbar. In this way, both ends of the laminated busbar can be easily displaced in the lamination direction with respect to the lamination holding region in the longitudinal middle of the laminated busbar. Thus, the positions of the both longitudinal ends of the laminated busbar can be easily adjusted when other connecting parts are connected to the both longitudinal ends of the laminated busbar.

(3) In the terminal block of (1) or (2), the plurality of busbars may be held in the laminated state by bonding the adjacent busbars to each other in the lamination holding region. In this way, sealability can be improved between the plurality of busbars.

(4) In the terminal block of (3), the adjacent busbars may be bonded to each other by ultrasonic bonding, welding or brazing. Sealability can be improved between the adjacent busbars.

(5) In the terminal block of (3), the adjacent busbars may be bonded to each other by diffusion bonding. Sealability can be improved between the adjacent busbars.

(6) In the terminal block of any one of (3) to (5), at least a part of the lamination holding region may be located in the block body. In this case, sealability can be improved between the lamination holding region of the laminated busbar and the block body. In this way, a liquid hardly leaks or intrudes along the laminated busbar.

(7) In the terminal block of (6), a sealant for filling a gap between the lamination holding region and the block body may be interposed between the lamination holding region and the block body. In this case, sealability can be more improved between the lamination holding region and the block body by the sealant.

(8) In the terminal block of any one of (3) to (7), an annular seal interposable between the block body and the device may be mounted on the block body. In this case, sealability between the block body and the device can be improved by the annular seal. Coupled with an improvement in sealability between the plurality of busbars due to the bonding of the adjacent busbars, sealability in the terminal block can be improved.

(9) In the terminal block of (1) or (2), the block body may hold the plurality of busbars in the laminated state relatively immovably in the lamination holding region. In this case, an operation of connecting the plurality of busbars separately from a manufacturing process of the block body can be omitted, and the terminal block can be easily manufactured.

(10) In the terminal block of any one of (1) to (9), the laminated busbar may include a first connection end formed with a first screw insertion hole penetrating through the plurality of busbars and a second connection end formed with a second screw insertion hole penetrating through the plurality of busbars. In this case, other connecting parts can be easily screwed to the first and second connection ends.

The laminated busbar of the present disclosure is as follows.

(11) The laminated busbar of the present disclosure is formed into an elongated shape and provided with a plurality of busbars laminated on each other, the plurality of busbars being held in a laminated state relatively immovably in a lamination holding region in one partial location in a longitudinal direction of the laminated busbar, the plurality of busbars being laminated in a relatively shiftable state in a separation region in another location in the longitudinal direction of the laminated busbar.

According to this laminated busbar, the plurality of busbars are held in the laminated state relatively immovably in the lamination holding region in the one partial location in the longitudinal direction of the laminated busbar, and the plurality of busbars are laminated in the relatively shiftable state in the region in the other location in the longitudinal direction of the laminated busbar. Thus, the laminated busbar can be easily bent in a lamination direction in the region in the other location in the longitudinal direction of the laminated busbar. Thus, position shift absorption performance is better as compared to a busbar formed of one metal plate. Further, since the plurality of busbars are held in the laminated state relatively immovably in the partial region in the longitudinal direction of the laminated busbar, a configuration for holding the laminated busbar in the laminated state at a low cost can be realized as compared to the case where the plurality of busbars are held in the laminated state relatively immovably in a plurality of locations.

(12) In the laminated busbar of (11), the lamination holding region is located in a middle in the longitudinal direction of the laminated busbar. In this case, both ends of the laminated busbar can be easily displaced in the lamination direction with respect to the lamination holding region in the longitudinal middle of the laminated busbar. Thus, the positions of the both longitudinal ends of the laminated busbar can be easily adjusted when other connecting parts are connected to the both longitudinal ends of the laminated busbar.

(13) In the laminated busbar of (11) or (12), the plurality of busbars may be held in the laminated state by bonding the adjacent busbars to each other in the lamination holding region. In this way, sealability can be improved between the plurality of busbars.

(14) In the laminated busbar of (13), the adjacent busbars may be bonded to each other by ultrasonic bonding, welding or brazing. Sealability can be improved between the adjacent busbars.

(15) In the laminated busbar of (13), the adjacent busbars may be bonded to each other by diffusion bonding. Sealability can be improved between the adjacent busbars.

### Details of Embodiment of Present Disclosure

Specific examples of a terminal block and a laminated busbar of the present disclosure are described below with reference to the drawings. Note that the present disclosure is not limited to these illustrations, but is represented by claims and intended to include all changes in the scope of claims and in the meaning and scope of equivalents.

### Embodiment

Hereinafter, a terminal block and a laminated busbar according to an embodiment are described. The terminal block is a component to be fixed to a device for electrically connecting this device to another electrical device. The laminated busbar is a component for electrical connection and is one type of a wiring component. An example in which the device is a rotating electric machine and the other electrical device is an inverter for controlling the drive of the rotating electric machine is described in this embodiment. It is not essential that the device and the other electrical device are the rotating electric machine or the inverter. For example, the other device may be a battery, a DC-DC converter, a junction box or the like.

<Concerning Overall Configuration of Mechatronically Integrated Unit Incorporated with Terminal Block>

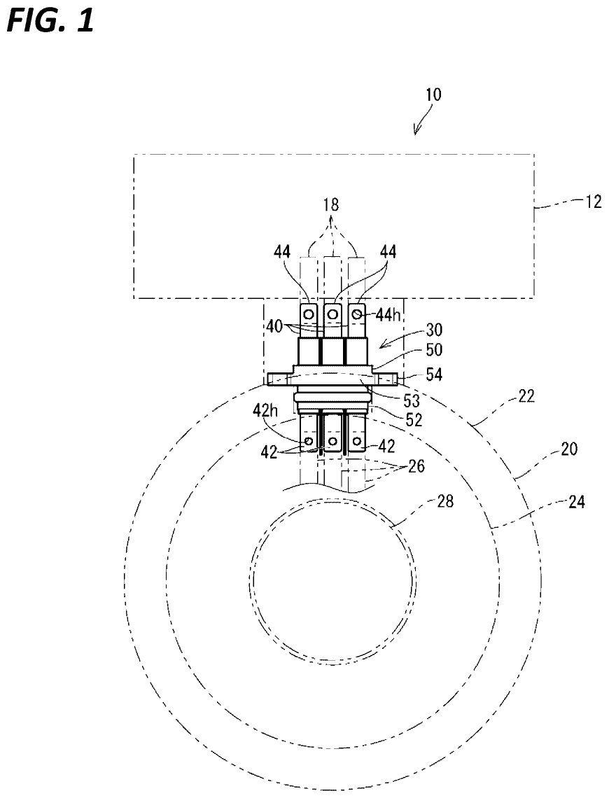

For the convenience of description, the overall configuration of a mechatronically integrated unit incorporated with the terminal block including the laminated busbar is described. FIG. 1 is a schematic diagram showing the mechatronically integrated unit 10.

The mechatronically integrated unit 10 is provided with a rotating electric machine 20 and an inverter 12.

The rotating electric machine 20 is provided with a case 22, an armature 20 and a field magnet 28. An example in which the armature 24 serving as a stator is fixed in the tubular case 22 is shown in FIG. 1. The field magnet 28 is arranged as a rotor in the armature 24. The field magnet 28 is rotated by a magnetic field generated by the armature 24 or the armature 24 is caused to generate an electromotive force by the rotation of the field magnet 28. In this embodiment, the rotating electric machine 20 is assumed to be usable as a three-phase alternating current motor. The rotating electric machine may be operable as a generator in addition to or instead of being operable as a motor.

The armature 24 includes a stator core and a plurality of coil wires. The stator core includes a plurality of teeth and the plurality of teeth are provided to surround a rotary shaft. Each coil wire is wound around one or more teeth. At least some of a plurality of end parts of the plurality of coil wires are pulled toward one end side in an axial direction of the armature from between the plurality of teeth.

The armature 24 includes coil connection ends 26. The coil connection end 26 is, for example, an elongated electrically conductive plate-like part. The coil connection end 26 is arranged on the one end side in the axial direction of the armature 24. A screw insertion hole 26h for screwing is formed in the coil connection end 26. The coil connection end 26 may be an end part of the coil wire itself or a metal plate connected to the coil wire by welding, screwing or the like. In this embodiment, three coil connection ends 26 corresponding to three phases are arranged in parallel at intervals on the one end side of the armature 24.

Further, the inverter 12 is a device including an inverter circuit. The inverter 12 is assumed to be integrated with the rotating electric machine 20. For example, the inverter 12 is integrated, such as by being fixed to the case 22 of the rotating electric machine 20 by a bolt.

The inverter 12 includes busbars 18 connected to output ends of the inverter circuit. The busbar 18 is an elongated plate-like member made of a metal plate material of copper, copper alloy or the like. The busbar 18 is formed with a screw insertion hole 18h for screwing. In this embodiment, three busbars 18 corresponding to the three phases extend in parallel at intervals from the inverter 12 toward the rotating electric machine 20.

The terminal block 30 is a component to be fixed to the case 22 of the rotating electric machine 20 for connecting the rotating electric machine 20 and the inverter 12. The terminal block 30 includes laminated busbars 40. One end part of the laminated busbar 40 is a first connection end 42 facing toward the inside of the case 22 and connected to an end part of the coil connection end 26. With the terminal block 30 fixed to the case 22, the first connection end 42 is arranged at a position overlapping the coil connection end 26. The other end part of the laminated busbar 40 is a second connection end 44 facing the outside of the case 22 and supported at such a position as to be connectable to an end part of the busbar 18 of the inverter 12. The second connection end 44 is arranged at a position overlapping the busbar 18 with the inverter 12 integrated with the rotating electric machine 20. In this embodiment, three laminated busbars 40 corresponding to the three phases are arranged in parallel at intervals.

The coil connection end 26 may be arranged to deviate from a predetermined position within the range of assembly tolerance. Further, the coil connection end 26 may be arranged to deviate from the predetermined position due to thermal expansion/contraction or the like. Thus, the coil connection end 26 and the first connection end 42 may be shifted in position. The terminal block 30 can function to absorb a position shift between the coil connection end 26 and the first connection end 42.

Particularly, a flat conductor may be used as the coil wire to enhance a coil occupancy factor. However, if the coil wire is a flat conductor, the coil becomes harder and less likely to be deformed than in the case of using a stranded wire as the coil wire. Thus, it becomes difficult to correct the position of the coil connection end 26 by the deformation of the coil wire. The terminal block 30 functions to absorb a position shift between the first connection end 42 and the coil connection end 26 in such a case.

Further, in integrating the inverter 12 with the rotating electric machine 20, the end part of the busbar 18 and the second connection end 44 of the laminated busbar 40 are thought to be shifted in position within the range of assembly tolerance. Further, with the inverter 12 integrated with the rotating electric machine 20, the end part of the busbar 18 and the second connection end 44 of the laminated busbar 40 are thought to be shifted in position due to thermal expansion/contraction.

The terminal block 30 can also function to absorb the position shift between the end part of the busbar 18 and the second connection end 44 of the laminated busbar 40.

### <Concerning Terminal Block>

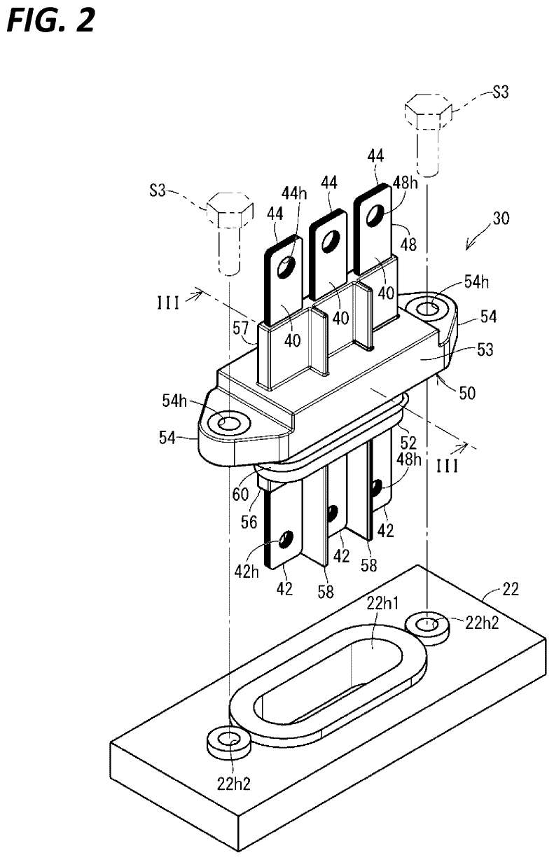

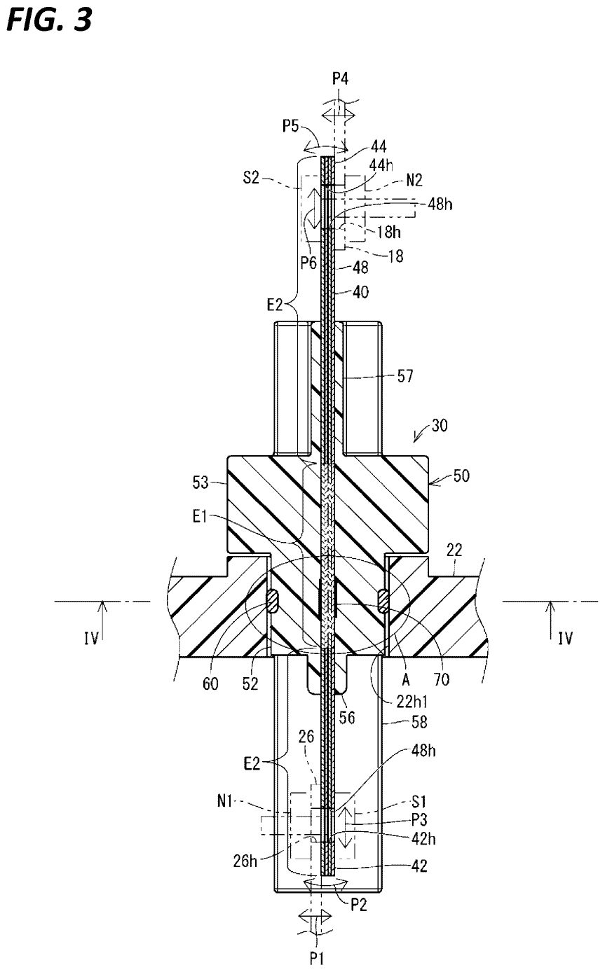

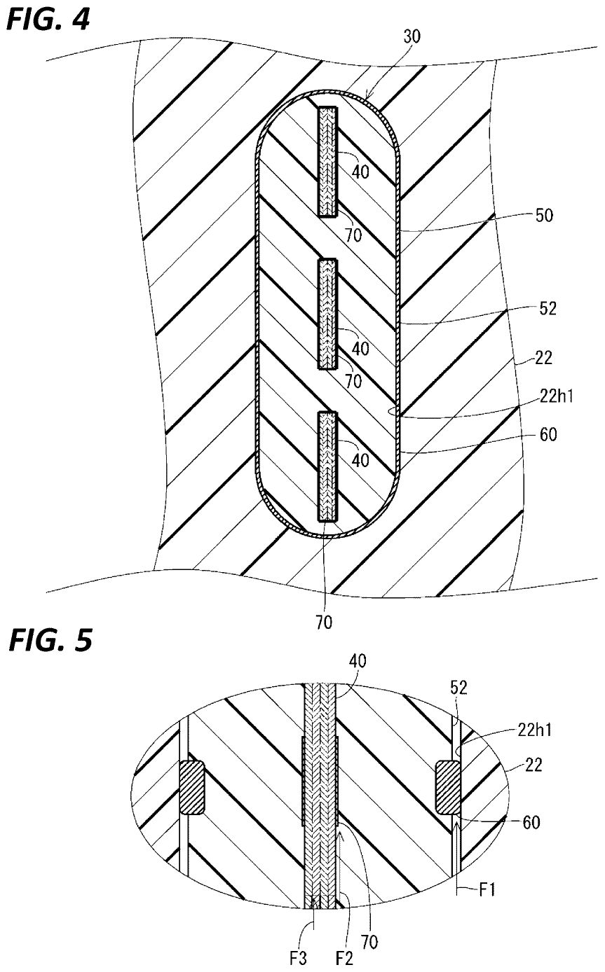

The terminal block 30 is more specifically described. FIG. 2 is a perspective view showing the terminal block 30. FIG. 3 is a section along III-III of FIG. 2. FIG. 4 is a section along IV-IV of FIG. 3. A state where the case 22 is removed from the terminal block 30 is shown in FIG. 2. A state where the terminal block 30 is fixed to the case 22 is shown in FIGS. 3 and 4. FIG. 5 is an enlarged view of a part A of FIG. 3. In FIGS. 2 to 5, the case 22 is partially shown.

The terminal block 30 includes the laminated busbars 40 and a block body 50.

The laminated busbar 40 is an electrically conductive component formed into an elongated shape. As described above, one end of the laminated busbar 40 is the first connection end 42 and the other end of the laminated busbar 40 is the second connection end 44.

The first connection end 42 is formed with a first screw insertion hole 42h. With the coil connection end 26 overlapped on the first connection end 42, a screw S1 is inserted through the screw insertion holes 26h, 42h. The screw S1 is threadably fastened to a nut N1. Then, the first connection end 42 and the coil connection end 26 are sandwiched between a head part of the screw S1 and the nut N1 and fixed in an electrically connected state.

The first screw insertion hole 42h is preferably larger than a diameter of a screw shaft part of the screw S1. In a direction along overlapping surfaces of the first connection end 42 and the coil connection end 26, the first screw insertion hole 42h may be set to be larger than the diameter of the screw shaft part of the screw S1 within such a range that the position shift between the first connection end 42 and the coil connection end 26 can be absorbed within a tolerance range. The above position shift can be absorbed also by the screw insertion hole 26h being larger than the diameter of the screw shaft part of the screw S1. Thus, the size of the first screw insertion hole 42h may be set also in consideration of the size of the screw insertion hole 26h.

The second connection end 44 is formed with a second screw insertion hole 44h. With the busbar 18 overlapped on the second connection end 44, a screw S2 is inserted through the screw insertion holes 18h, 44h. The screw S2 is threadably fastened to a nut N2. Then, the second connection end 44 and the busbar 18 are sandwiched between a head part of the screw S2 and the nut N2 and fixed in an electrically connected state. The second screw insertion hole 44h is preferably larger than a diameter of a screw shaft part of the screw S2. In a direction along overlapping surfaces of the second connection end 44 and the busbar 18, the second screw insertion hole 44h may be set to be larger than the diameter of the screw shaft part of the screw S2 within such a range that the position shift between the second connection end 44 and the busbar 18 can be absorbed within a tolerance range. The above position shift can be absorbed also by the screw insertion hole 18h being larger than the diameter of the screw shaft part of the screw S2. Thus, the size of the second screw insertion hole 44h may be set also in consideration of the size of the screw insertion hole 18h.

In this embodiment, the terminal body 30 includes three laminated busbars 40. The terminal body 30 only has to include at least one laminated busbar.

The laminated busbar 40 includes a plurality of busbars 48 laminated on each other. The busbar 48 is a busbar thinner than the entire laminated busbar 40. The busbar 48 is made of a metal plate of copper, copper alloy, aluminum, aluminum alloy or the like. The busbar 48 is in the form of an elongated metal plate. In this embodiment, the busbar 48 is formed into a rectangular shape long in one direction. It is also assumed that end parts of the busbar 48 are shaped to be rounded.

Holes 48h for forming the screw insertion hole 42h, 44h are formed on both ends of the busbar 48.

The plurality of busbars 48 are formed to have the same shape. By laminating the plurality of busbars 48, the laminated busbar 40 is configured. In the laminated busbar 40, the first screw insertion hole 42h or the second screw insertion hole 44h is formed by overlapping a plurality of the holes 48h.

As described later, if the laminated busbar 40 is deformed in a lamination direction, it is assumed that the positions of the holes 48h are shifted between the laminated busbars 48. The hole 48h is preferably larger than the diameter of the screw S1 or S2 so that the screw S1 or S2 is insertable into the screw insertion hole 42h, 44h even if the holes 48h are shifted in position.

The thickness of the laminated busbar 40, the thickness of the busbars 48 and the number of the busbars 48 are arbitrary. These thicknesses and number are set in consideration of an allowable current value, ease of deformation, processability and the like required for the laminated busbar 40.

For example, the laminated busbar 40 may be configured by laminating three to six busbars 48 having a thickness of 0.3 mm to 1 mm. Further, the laminated busbar 40 may be, for example, configured by laminating four to five busbars 48 having a thickness of 0.4 mm to 0.6 mm. An example in which four busbars 48 having the same shape are laminated is described in this embodiment.

It is not essential that the plurality of busbars 48 are formed to have the same shape. For example, a laminated busbar may be configured by laminating a plurality of busbars having different thicknesses. Further, holes having different shapes may be formed in a plurality of busbars and the first or second screw insertion hole 42h or 44h may be formed by common opening parts of the plurality of holes.

In a lamination holding region E1 in one partial location in a longitudinal direction of the laminated busbar 40, the plurality of busbars 48 are held in the laminated state relatively immovably. The holding of the plurality of busbars 48 in the laminated state relatively immovably means that relative position shifts of the plurality of busbars 48 are suppressed regardless of whether or not the plurality of busbars 48 are joined to each other. In the lamination holding region E1, the adjacent busbars 48 are preferably in direct contact with each other, but this is not essential.

Further, in separation regions E2 in other locations in the longitudinal direction of the laminated busbar 40, the plurality of busbars 48 are laminated in a relatively shiftable state. That the plurality of busbars 48 are laminated in a relatively shiftable state means that the adjacent busbars 48 are not bonded to each other and, accordingly, the adjacent busbars 48 rub against each other and the respective busbars 48 can be bent in the thickness direction (lamination direction of the laminated busbar 40).

In this embodiment, the lamination holding region E1 is located in an intermediate part in the longitudinal direction of the laminated busbar 40. Thus, the separation regions E2 are located on both ends in the longitudinal direction of the laminated busbar 40. That is, the first and second connection ends 42, 44 are formed in the separation regions E2.

The lamination holding region E1 is preferably formed in a region including a longitudinal center of the laminated busbar 40. The separation regions E2 on the both ends of the lamination holding region E1 preferably have the same length. The lamination holding region E1 may be formed in a region shifted to either one of the ends of the laminated busbar 40.

As the lamination holding region E1 becomes longer, the plurality of busbars 48 are more easily reliably held in the laminated state and less likely to be separated. If the separation regions E2 are long, the laminated busbar 40 can be easily bent in the lamination direction in the separation regions E2. Lengths of the lamination holding region E1 and the separation regions E2 can be set according to the integration holding performance of the laminated busbar 40, ease of deformation desired in the separation regions E2 and the like.

A configuration for holding the plurality of busbars 48 in the laminated state relatively immovably in the lamination holding region E1 is arbitrary. In this embodiment, the plurality of busbars 48 are held in the laminated state by joining the adjacent busbars 48 to each other in the lamination holding region E1. That is, in the lamination holding region E1, the plurality of busbars 48 are integrated to maximally eliminate gaps between the adjacent busbars 48.

The adjacent busbars 48 may be joined, for example, by ultrasonic bonding, by welding such as resistance welding or laser welding or by brazing such as soldering. In these cases, the plurality of busbars 48 are electrically connected in the lamination holding region E1. The adjacent busbars 48 may be joined to each other, for example, by an adhesive.

The configuration for holding the plurality of busbars 48 in the laminated state is not limited to the above example. The plurality of busbars 48 may be held in the laminated state by hardening around the plurality of busbars 48 by a resin or binding the plurality of busbars 48 by a binding member such as a zip tie. In this embodiment, the block body 50 can be understood to hold the plurality of busbars 48 in the laminated state relatively immovably. In this case, parts of the plurality of busbars 48 in the block body 50 constitute a lamination holding region and parts thereof extending outward from block body 50 constitute separation regions.

Since the separation region E2 is adjacent to the lamination holding region E1, the plurality of busbars 48 are held in the laminated state also in the separation region E2. However, in the separation region E1, the plurality of busbars 48 are not bonded to each other and can be shifted in position to rub against each other. Thus, in the separation region E2, the laminated busbar 40 can be easily bent in the lamination direction by the plurality of busbars 48 being shifted in position to rub against each other.

The block body 50 is a part to be fixed to the rotating electric machine 20, which is an example of the device, while holding the laminated busbars 40. Here, the case 22 of the rotating electric machine 20 is formed with a mounting hole 22h1. The mounting hole 22h1 is a hole penetrating between the inside and outside of the case 22. In this embodiment, the mounting hole 22h1 is an elongated through hole. The case 22 is formed with a flat part, and the mounting hole 22h1 is formed in that flat part. Screw holes 22h2 are formed around the mounting hole 22h in the flat part. In this embodiment, the screw holes 22h2 are formed on both outer longitudinal sides of the mounting hole 22h1 in the case 22. With the block body 50 partially inserted in the mounting hole 22h1, the block body 50 is fixed to the case 22 by screwing, using the screw holes 22h2.

The block body 50 is, for example, assumed as an insulator such as a resin. The resin forming the block body 50 is, for example, polyamide 6T (PA6T), polyphenylene sulfide (PPS) or polybutylene terephthalate (PBT) and, preferably, PA6T. If the rotating electric machine 20 is of an oil-cooling type, the resin forming the block body 50 is preferably PA6T or PPS. If the rotating electric machine 20 is of a water-cooling type, the resin forming the block body 50 may be PBT. The plurality of laminated busbars 40 are supported at fixed positions with respect to the rotating electric machine 20 by the block body 50.

The block body 50 includes an inserting portion 52, a base portion 53, screwing portions 54, extended holding portions 56, 57 and partitioning portions 58.

The inserting portion 52 is formed into a shape insertable into the mounting hole 22h1. Here, the inserting portion 52 has an outer peripheral shape, which is the same as the inner peripheral surface of the mounting hole 22h1 or smaller than the mounting hole 22h1. A length of the inserting portion 52 is set to be equal to a length of the mounting hole 22h1 in a penetration direction.

An annular seal 60 is mounted on the outer periphery of the inserting portion 52. For example, an annular groove is formed in the outer periphery of the inserting portion 52 and the annular seal 60 is mounted in this annular groove. The annular seal 60 is, for example, an annular member made of a resilient material such as rubber. With the inserting portion 52 inserted in the mounting hole 22h1, the annular seal 60 is interposed in a compressed state between the inserting portion 52 of the block body 50 and the inner peripheral surface of the mounting hole 22h1 of the case 22. In this way, the leakage or intrusion of a liquid through and between the mounting hole 22h1 and the inserting portion 52 is suppressed.

The base portion 53 is a part connected to a base end side, which is one end side, of the inserting portion 52. The base portion 53 is formed into a shape larger than the inserting portion 52. Here, the base portion 53 is formed into a flat rectangular parallelepiped shape larger than the mounting hole 22h1.

The screwing portion 54 is a part projecting from the outer periphery of the base portion 53. In this embodiment, the block body 50 includes two screwing portions 54. The two screwing portions 54 project outward from both longitudinal ends of the base portion 53. The screwing portion 54 is formed with a screw insertion hole 54h.

With the inserting portion 52 inserted in the mounting hole 22h1, the base portion 53 can contact the outer surface of the case 22 around the mounting hole 22h1. In this state, a pair of the screwing portions 54 are arranged on a pair of the screw holes 22h2. By inserting screws S3 into the screw insertion holes 54h and threadably fastening the screws S3 to the screw holes 22h2 of the case 22, the block body 50 is fixed to the case 22.

The laminated busbars 40 are held to penetrate between the inside and outside of the case 22 by the inserting portion 52 and the base portion 53. In this embodiment, the plurality of (three) laminated busbars 40 are held in parallel at intervals by the inserting portion 52 and the base portion 53. The plurality of (three) laminated busbars 40 are held in a state insulated from each other by the inserting portion 52 and the base portion 53.

Longitudinal intermediate parts of the laminated busbars 40 are embedded in the inserting portion 52 and the base portion 53. A part of the laminated busbar 40 on the side of the first connection end 42 projects from a tip side of the inserting portion 52. A part of the laminated busbar 40 on the side of the second connection end 44 projects toward a side opposite to the inserting portion 52 from the base portion 53.

As described above, with the block body 50 fixed to the case 22, the first connection ends 42 of the laminated busbars 40 are arranged at positions to be able to overlap the coil connection ends 26. Further, the second connection ends 44 of the laminated busbars 40 are arranged at positions to be able to overlap the busbars 18.

The extended holding portion 56 projects from the tip side of the inserting portion 52 while partially covering each laminated busbar 40. Accordingly, parts of the laminated busbars 40 near the first connection ends 42 and coming out from a tip side of the extended holding portion 56 are exposed from the block body 50.

Further, the extended holding portion 57 projects from the base portion 53 while partially covering each laminated busbar 40. Accordingly, parts of the laminated busbars 40 near the second connection ends 44 and coming out from a tip side of the extended holding portion 57 are exposed from the block body 50.

The partitioning portions 58 are plate-like parts extending in a direction orthogonal to an arrangement direction of the plurality of laminated busbars 40 on the tip side of the inserting portion 52 and between the respective laminated busbars 40. Such partitioning portions 58 can partition between the parts of the respective laminated busbars 40 near the first connection ends 42.

The extended holding portions 56, 57 may be omitted. The partitioning portions 58 may be omitted.

The lamination holding region E1 is preferably at least partially located in the block body 50. In this embodiment, the lamination holding region E1 is entirely located in the inserting portion 52 and the base portion 53.

A sealant 70 for filling a gap between the lamination holding region E1 and the block body 50 is preferably interposed between the lamination holding region E1 of the laminated busbar 40 and the block body 50. The sealant 70 needs not be present in the entire lamination holding region E1 and may be interposed between at least a part of the lamination holding region E1 and the block body 50.

The sealant 70 functions to close a liquid intrusion path between the lamination holding region E1 and the block body 50 by being interposed between the lamination holding region E1 and the block body 50. For example, an elastic adhesive can be used as the sealant 70. An epichlorohydrin rubber adhesive can be, for example, used.

The terminal block 30 is, for example, manufactured as follows. That is, the laminated busbars 40 are manufactured by joining parts of the plurality of busbars 48 in the length direction. The sealant 70 is attached to parts of the laminated busbars 40 to be embedded in the block body 50.

The laminated busbars 40 are set in a mold for molding the block body 50. A molten resin for forming the block body 50 is poured into the mold and the block body 50 is molded with the laminated busbars 40 as inserts. In this way, the terminal block 30 is manufactured in which the longitudinal intermediate parts of the laminated busbars 40 are embedded as insert parts in the block body 50. Collars made of metal may be embedded in the screw insertion holes 54h.

Unlike the above manufacturing method, after the block body 50 including through holes, into which the laminated busbars 40 are insertable, is molded, the laminated busbars 40 may be passed through these through holes to manufacture the terminal block 30.

An operation example of connecting the rotating electric machine 20 and the inverter 12 by the terminal block 30 is described.

First, in the rotating electric machine 20, the armature 24 and the like are incorporated into the case 22 and the coil connection ends 26 are arranged at predetermined positions in the case 22. In this state, the inserting portion 52 of the block body 50 is inserted into the mounting hole 22h1 of the case 22. Then, the first connection ends 42 are arranged at positions overlapping the coil connection ends 26. However, the position of at least one of the first connection end 42 and the coil connection end 26 may be possibly shifted from a designed predetermined position in the lamination direction of the laminated busbar 40 (see an arrow P1 of FIG. 3). In such a case, the separation region E2 expanding in the part of the laminated busbar 40 near the first connection end 42 can be easily bent in the lamination direction according to the position of the coil connection end 26 (see arrow P2 of FIG. 3). In this way, the first connection end 42 and the coil connection end 26 can be screw-fixed while being overlapped in surface contact with each other.

Note that the position of at least one of the first connection end 42 and the coil connection end 26 may be possibly shifted from the designed predetermined position in the direction orthogonal to the lamination direction of the laminated busbar 40 (see an arrow P3 of FIG. 3). In preparation for such a case, at least one of the screw holes 42h and 26h may be, for example, made larger than the diameter of the screw S1. In this case, the first connection end 42 and the coil connection end 26 can be screw-fixed with the screw S1 inserted in the screw insertion hole 42h or 26h at a position deviated according to a shift amount.

The second connection ends 44 of the laminated busbars 40 project outside the terminal block 30 fixed to the case 22. The inverter 12 is arranged on the rotating electric machine 20, and the end parts of the busbars 18 are arranged at positions overlapping the second connection ends 44. However, the position of at least one of the second connection end 44 and the end part of the busbar 18 may be possibly shifted from a designed predetermined position in the lamination direction of the laminated busbar 40 (see an arrow P4 of FIG. 3). In such a case, the separation region E2 expanding in the part of the laminated busbar 40 near the second connection end 44 can be easily bent in the lamination direction according to the position of the end part of the busbar 18 (see arrow P5 of FIG. 3). In this way, the second connection end 44 and the end part of the busbar 18 can be screw-fixed while being overlapped in surface contact with each other.

Also in this case, the position of at least one of the second connection end 44 and the end part of the busbar 18 may be possibly shifted from the designed predetermined position in the direction orthogonal to the lamination direction of the laminated busbar 40 (see an arrow P6 of FIG. 3). As in the above case, at least one of the screw holes 44h and 18h may be, for example, made larger than the diameter of the screw S2.

Note that a screw fixing order by the screws S1, S2 and S3 is arbitrary.

Also after the inverter 12 is integrated with the rotating electric machine 20, the position shift of the first connection end 42 and the coil connection end 26 and the position shift of the second connection end 44 and the end part of the busbar 18 may occur or become larger due to thermal expansion/contraction or the like. Also in such a case, the separation regions E2 of the laminated busbar 40 are easily deformed, whereby the position shifts can be dealt with.

With the inverter 12 integrated with the rotating electric machine 20, it may be desired to suppress the passage of a liquid between the inside and outside of the rotating electric machine 20. For example, if the rotating electric machine 20 is of an oil-cooling type, oil is present in the case 22. It is required to prevent the leakage of the oil to the outside of the rotating electric machine 20 also in the terminal block 30.

A gap is possibly formed between the mounting hole 22h1 of the case 22 and the terminal block 30. However, the leakage of the liquid is suppressed between the mounting hole 22h1 of the case 22 and the terminal block 30 by the annular seal 60 (see an arrow F1 of FIG. 3).

Further, a tiny gap is possibly formed between the laminated busbar 40 and the block body 50. However, the leakage of the liquid is suppressed between the lamination holding region E1 of the laminated busbar 40 and the block body 50 by the sealant 70 (see an arrow F2 of FIG. 3).

Gaps are also possibly formed between the busbars 48 and the block body 50. However, since the adjacent busbars 48 are joined in the lamination holding region E1, the leakage of the liquid through and between the busbars 48 is also suppressed (see an arrow F3 of FIG. 3). Particularly, if the lamination holding region E1 and the sealant 70 at least partially overlap in the longitudinal direction of the laminated busbar 40, a water path along the laminated busbar 40 is closed by the lamination holding region E1 and the sealant 70.

Thus, oil leakage from the case 22 is suppressed in the terminal block 30.

### <Effects, etc.>

According to the terminal block 30 and the laminated busbar 40 configured as described above, the plurality of busbars 48 are held in the laminated state relatively immovably in the lamination holding region E1 in one partial location in the longitudinal direction of the laminated busbar 40, and the plurality of busbars 48 are laminated in the relatively shiftable state in the separation regions E2 in the other locations in the longitudinal direction of the laminated busbar 40.

Thus, the laminated busbar can be easily bent in the lamination direction in the other regions in the longitudinal direction of the laminated busbar. Thus, position shift absorption performance is better as compared to a busbar formed of one metal plate. In this way, an operation of connecting the inverter 12 to the rotating electric machine 20 is facilitated.

Further, the plurality of busbars 48 can be collectively handled as one wiring member. For example, the end parts of the plurality of busbars 48 can be held in an overlapped state and used as the first and second connection ends 42, 44 used for connection to the busbar 18 or the coil connection end 26. In this case, since the plurality of busbars 48 are held in the laminated state relatively immovably in one partial region in the longitudinal direction of the laminated busbar 40, the configuration for holding the laminated busbar in the laminated state at a low cost can be realized as compared to the case where a plurality of busbars are held in a laminated state relatively immovably in a plurality of locations.

Further, since the lamination holding region E1 is located in the middle in the longitudinal direction of the laminated busbar 40, the both ends of the laminated busbar 40 can be easily displaced in the lamination direction as the separation regions E2. Thus, when the coil connection end 26 or the end part of the busbar 18 is connected as another connecting part to the first and second connection ends 42, 44 on the both longitudinal ends of the laminated busbar 40, the positions of the first and second connection ends 42, 44 on the both ends can be easily adjusted.

Further, processing marks of the lamination holding region E1 hardly remain on the both ends of the laminated busbar 40. For example, if the plurality of busbars 48 are ultrasonically bonded in the lamination holding region E1, pressure marks are thought to remain due to ultrasonic bonding. Further, welding marks are thought to remain when the plurality of busbars 48 are melted and welded in the lamination holding region E1. If processing marks remain in the first or second connection end 42, 44, surface smoothness is lost and the first or second connection end 42, 44 may not be possibly held in surface contact with the coil connection end 26 or the busbar 18. By setting the lamination holding region E1 in the longitudinal intermediate part of the laminated busbar 40, the surfaces of the first and second connection ends 42, 44 become smooth and are connected in surface contact with the coil connection end 26 or the busbar 18, whereby satisfactory electrical connection is achieved.

Further, since the adjacent busbars 48 are bonded to each other to hold the plurality of busbars 48 in the laminated state in the lamination holding region E1, gaps are hardly formed between the adjacent busbars 48. In this way, sealability can be improved between the plurality of busbars and the passage of a liquid through and between the busbars 48 is suppressed.

Particularly, if the adjacent busbars 48 are bonded by ultrasonic bonding, welding, brazing or diffusion bonding, sealability can be improved between the adjacent busbars 48. Further, the busbars 48 can be held in the laminated state by a compact configuration without adding a separate configuration for lamination.

Further, if at least a part of the lamination holding region E1, in which the adjacent busbars 48 are bonded to each other, is located in the block body 50, both the passage of water through and between the busbars 48 and the passage of water through and between the lamination holding region E1 of the laminated busbar 40 and the block body 50 can be suppressed in the block body 50. In this way, the liquid hardly leaks or intrudes along the laminated busbar 40.

Further, if the sealant 70 for filling the gap between the lamination holding region E1 and the block body 50 is interposed between the lamination holding region E1 and the block body 50, sealability can be more improved between the lamination holding region E1 and the block body 50 by the sealant 70.

Further, if the annular seal 60 to be interposed between the block body 50 and an inner peripheral part of the mounting hole 22h1 is mounted on the block body 50, sealability between the block body 50 and the case 22 can be improved by this annular seal 60. Coupled with an improvement in sealability due to the bonding of the adjacent busbars 48, sealability in the terminal block 30 can be improved.

Since the laminated busbar 40 includes the first connection end 42 formed with the first screw insertion hole 42h and the second connection end 44 formed with the second screw insertion hole 44h, other connecting parts can be easily screwed to the first and second connection ends 42, 44.

### Modifications

The example in which the laminated busbars 40 are held by the block body 50 is described in the above embodiment. The laminated busbars 40 may be utilized as wiring members for connecting electrical components to each other without the use of the block body 50.

The example in which the lamination holding region E1 is located in the longitudinal intermediate part of the laminated busbar 40 is described in the above embodiment. The lamination holding region E1 may be located on one or the other end of the laminated busbar 40. That is, the first connection end 42 may be the lamination holding region E1. In this case, a region from the longitudinal middle of the laminated busbar 40 to the second connection end 44 is the separation region E2. The second connection end 44 may be the lamination holding region E1. In this case, a region from the longitudinal middle of the laminated busbar 40 to the first connection end 42 is the separation region E2. Since the other end can be easily deformed based on the one end of the laminated busbar, position shift absorption performance is excellent.

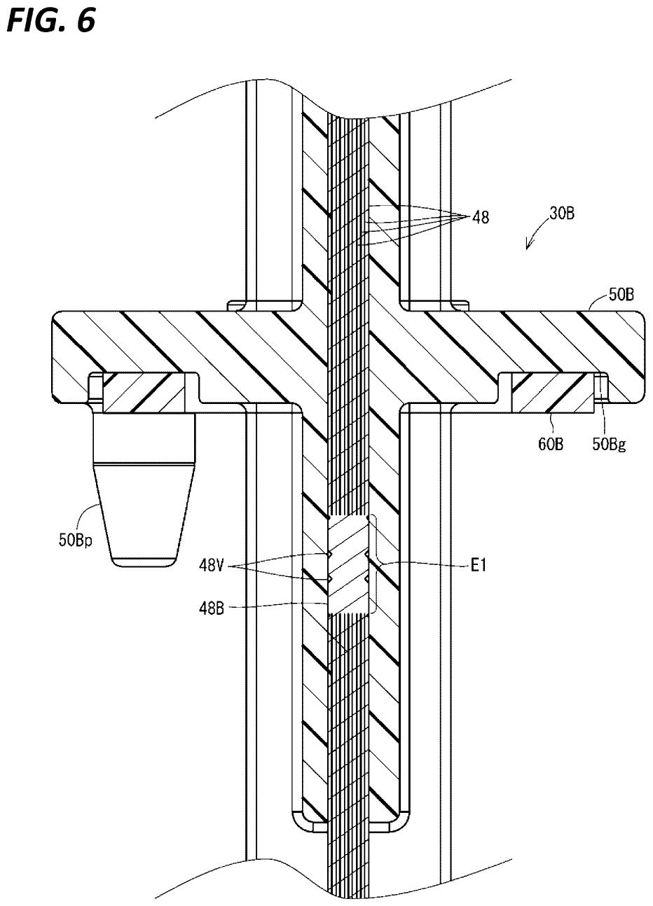

As in a terminal block 30B according to a modification shown in FIG. 6, the adjacent busbars 48 may be bonded by diffusion bonding in the lamination holding region E1. A diffusion-bonded part of the adjacent busbars 48 is a diffusion-bonded portion 48B.

The diffusion bonding is a bonding method for realizing metal bonding between joint surfaces by bringing the adjacent busbars 48 into contact with each other and pressurizing the busbars 48 to such an extent as to be least plastically deformed under a temperature condition equal to or lower than a melting point of a raw material of the busbars 48. The diffusion bonding is preferably performed in a vacuum state or an inert gas atmospheric state where surface oxidation can be suppressed. Gaps disappear between the diffusion-bonded busbars 48 and the laminated busbars 48 are integrated. In the diffusion-bonded portion 48E, boundary marks may remain. The boundary marks may be observed as tiny gaps remaining between the busbars 48 or steps or grooves remaining on side surfaces of the diffusion-bonded portion 48E. Whether or not, or to which extent the boundary marks remain depends on various conditions such as a temperature, an atmosphere and a pressure condition.

Note that although the lamination holding region E1 in the example shown in FIG. 6 is shorter than the lamination holding region E1 in the embodiment, this length is not particularly limited.

In this modification, grooves 48V along a direction intersecting (here, orthogonal to) an extension direction of the busbars 48 are formed in the outer surfaces of the busbars 48 located on the outermost sides in the lamination direction. These grooves 48V can function to keep the sealant 70 in the lamination holding region E1 when the sealant 70 (see FIG. 5) is interposed between a block body 50B corresponding to the block body 50 and the lamination holding region E1.

In this modification, the inserting portion 52 in the above embodiment is omitted. An annular seal 60B corresponding to the annular seal 60 is arranged in an annular groove 50Bg formed in a part of the block body 50B facing the surface of the case 22. The annular seal 60B seals between the block body 50B and the case 22 by being interposed in a compressed state between the block body 50B and the surface of the case 22. A configuration example of the annular seal is not limited to this example and the annular seal may be externally fit to an inserting portion integrally formed to a block body as in the above embodiment.

In this modification, the block body 50B is formed with a positioning pin 50Bp and this positioning pin 50Bp is inserted into a positioning hole formed in the case 22. The positioning pin 50Bp may be omitted.

In the above embodiment and modification, the adjacent busbars 48 are described to be bonded to each other in the lamination holding region E1. It is not essential that the adjacent busbars 48 are bonded in the lamination holding region E1.

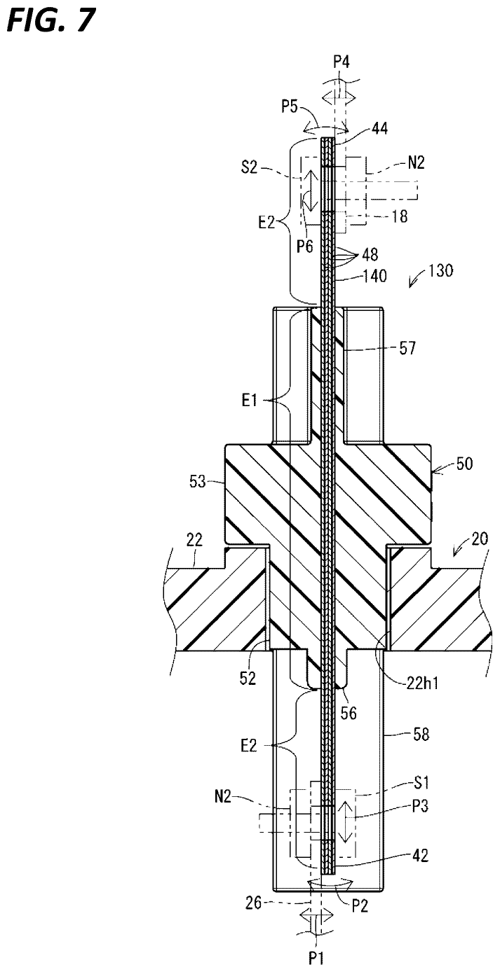

As in a terminal block 130 according to a modification shown in FIG. 7, a block body 50 may be molded with laminated busbars 140 formed by laminating a plurality of busbars 48 without bonding the busbars 48 to each other as insert parts.

In this case, the block body 50 holds parts (here, intermediate parts) in a longitudinal direction of the plurality of busbars 48 in the laminated state relatively immovably. That is, a part of the laminated busbar 140 in the block body 50 is the lamination holding region E1 and parts extending outward from the block body 50 are the separation regions E2. In this modification, the annular seal 60 may be omitted. Further, the sealants 70 may also be omitted.

Also in this modification, the parts of the laminated busbar 140 extending out from the terminal block 130 can be easily deformed in a lamination direction. Thus, functions and effects similar to those of the above embodiment, except sealability, can be achieved.

For example, in the rotating electric machine 20 of a water-cooling type, water is circulated in a cooling water passage of the case 22. Thus, sealability is not required between a space for accommodating the armature 24 and the like in the case 22 and an outside space. In such a case, the terminal block 130 may be applied.

According to this modification, since the block body 50 holds the plurality of busbars 48 in the laminated state relatively immovably in the lamination holding region E1, an operation of connecting the plurality of busbars 48 separately from a manufacturing process of the block body 50 can be omitted and the terminal block 130 can be easily manufactured.

Note that the respective configurations described in the above embodiment and modifications can be appropriately combined without technically contradicting each other.

### LIST OF REFERENCE NUMERALS

10 mechatronically integrated unit
12 inverter
18 busbar
18h screw insertion hole
20 rotating electric machine (device)
22 case
22h1 mounting hole
22h2 screw hole
24 armature
26 coil connection end
26h screw insertion hole
28 field magnet
30, 30B, 130 terminal block
40,140 laminated busbar
42 first connection end
42h first screw insertion hole
44 second connection end
44h second screw insertion hole
48 busbar
48B diffusion-bonded portion
48h hole
48V groove
50,50B body
50Bg annular groove
50Bp positioning pin
52 inserting portion
53 base portion
54 screwing portion
54h screw insertion hole
56, 57 extended holding portion
58 partitioning portion
60,60B annular seal
70 sealant
E1 lamination holding region
E2 separation region
N1, N2 nut
S1, S2, S3 screw

1. A terminal block to be fixed to a device, comprising:
a laminated busbar formed into an elongated shape; and
a block body to be fixed to the device while holding the laminated busbar,
the laminated busbar including a plurality of busbars laminated on each other,
the plurality of busbars being held in a laminated state relatively immovably in a lamination holding region in one partial location in a longitudinal direction of the laminated busbar, the plurality of busbars being laminated in a relatively shiftable state in a separation region in another location in the longitudinal direction of the laminated busbar, and
the block body being a molded product molded with a longitudinal intermediate part of the laminated busbar as an insert part.

2. The terminal block of claim 1, wherein the lamination holding region is located in a middle in the longitudinal direction of the laminated busbar.

313. A terminal block to be fixed to a device, comprising:
a laminated busbar formed into an elongated shape; and
a block body to be fixed to the device while holding the laminated busbar,
the laminated busbar including a plurality of busbars laminated on each other,
the plurality of busbars being held in a laminated state relatively immovably in a lamination holding region in one partial location in a longitudinal direction of the laminated busbar, the plurality of busbars being laminated in a relatively shiftable state in a separation region in another location in the longitudinal direction of the laminated busbar,
the plurality of busbars being held in the laminated state by joining the adjacent busbars to each other in the lamination holding region,
the longitudinal intermediate part of the laminated busbar being held in a state embedded in the block body, and
the lamination holding region being entirely located in the block body.

4. The terminal block of claim 3, wherein the adjacent busbars are bonded to each other by ultrasonic bonding, welding or brazing.

5. The terminal block of claim 3, wherein the adjacent busbars are bonded to each other by diffusion bonding.

6. The terminal block of claim 3, wherein at least a part of the lamination holding region is located in the block body.

7. A terminal block to be fixed to a device, comprising:
a laminated busbar formed into an elongated shape; and
a block body to be fixed to the device while holding the laminated busbar,
the laminated busbar including a plurality of busbars laminated on each other,
the plurality of busbars being held in a laminated state relatively immovably in a lamination holding region in one partial location in a longitudinal direction of the laminated busbar, the plurality of busbars being laminated in a relatively shiftable state in a separation region in another location in the longitudinal direction of the laminated busbar,
the plurality of busbars being held in the laminated state by joining the adjacent busbars to each other in the lamination holding region,
at least a part of the lamination holding region being located in the block body,
a sealant for filling a gap between the lamination holding region and the block body being interposed between the lamination holding region and the block body, and
the lamination holding region and the sealant at least partially overlapping in the longitudinal direction of the laminated busbar.

8. The terminal block of claim 3, wherein an annular seal interposable between the block body and the device is mounted on the block body.

9. The terminal block of claim 1, wherein the block body holds the plurality of busbars in the laminated state relatively immovably in the lamination holding region.

10. The terminal block of claim 1, wherein the laminated busbar includes a first connection end formed with a first screw insertion hole penetrating through the plurality of busbars and a second connection end formed with a second screw insertion hole penetrating through the plurality of busbars.

11. A laminated busbar formed into an elongated shape, comprising a plurality of busbars laminated on each other,
the plurality of busbars being held in a laminated state relatively immovably in a lamination holding region in one partial location in a longitudinal direction of the laminated busbar, the plurality of busbars being laminated in a relatively shiftable state in a separation region in another location in the longitudinal direction of the laminated busbar, and
the lamination holding region being located in a middle in the longitudinal direction of the laminated busbar and formed in a region including a longitudinal center of the laminated busbar.

12. (canceled)

13. The laminated busbar of claim 11, wherein the plurality of busbars are held in the laminated state by bonding the adjacent busbars to each other in the lamination holding region.

14. The laminated busbar of claim 13, wherein the adjacent busbars are bonded to each other by ultrasonic bonding, welding or brazing.

15. The laminated busbar of claim 13, wherein the adjacent busbars are bonded to each other by diffusion bonding.
